(19) United States
(12) Patent Application Publication
(10) Pub. No.: US 2026/0298676 A1
(43) Pub. Date: Oct. 1, 2026

(54) RESTRAINT SYSTEM FOR SENSOR CONNECTORS IN A VEHICLE STEERING SYSTEM

(71) Applicant: ZF CV Systems Global GmbH, Bern (CH)

(72) Inventor: Ingo BECKER, Linnich (DE)

(21) Appl. No.: 19/571,656

(22) Filed: Mar. 19, 2026

(30) Foreign Application Priority Data
Mar. 26, 2025 (DE) 10 2025 111 754.3

(51) Int. Cl. G01D 11/24

(52) U.S. Cl. CPC G01D 11/245

(57) ABSTRACT

A sensor system housing, including a housing part with a sensor and a sensor connector, the sensor connector configured to connect the sensor to a wire harness introduced through an insertion region. The sensor system housing includes a cover configured to seal the housing part after assembly, a restraint system configured to block the sensor connector from sliding out of the sensor being provided on a lower side of the cover that points into the housing part after assembly. The restraint system includes a peg protruding from the lower side of the cover and a contour that, proceeding from the lower side of the cover, leads in a direction of a base of the housing part. The contour is formed such that, after the cover is attached to the housing part, the contour is positioned on a region of the sensor connector that points to the wire harness.

### CROSS REFERENCE TO RELATED APPLICATIONS

This application claims benefit to German Patent Application No. DE 10 2025 111 754.3, filed on March 26, 2025, which is hereby incorporated by reference herein.

### FIELD

The present invention relates to electrical plug connectors.

### BACKGROUND

Current steering systems require a high level of safety integrity and therefore also special measures such as redundant sub-components and redundant signal tracks, so that even in spite of a "single error" of a signal track, the entire system can continue to operate through the second error-free signal track.

When using plug connectors in a system with redundant signal paths, it is important to ensure that the (electrical) plug connector is never released throughout its service life. In current plug connector systems, therefore, at least one restraint, for example in the form of a latching device, is often installed. However, it can still occur that the plug connector is released due to human error, e.g. due to not being latched during assembly, or due to operation in the vehicle, for example by virtue of vibrations and the effects of wear. Although these risks are relatively low in statistical terms, additional restraints must be installed to prevent any unwanted release of the plug connector.

### SUMMARY

In an embodiment, the present disclosure provides a sensor system housing, comprising a housing part with a sensor disposed therein and a sensor connector disposed therein, the sensor connector being configured to connect the sensor to a wire harness introduced into the housing part through an insertion region. The sensor system housing further comprises a cover configured to seal the housing part after assembly, a restraint system configured to block the sensor connector from sliding out of the sensor being provided on a lower side of the cover that points into the housing part after assembly. The restraint system is formed from a peg which protrudes from the lower side of the cover and has a contour that, proceeding from the lower side of the cover, leads in a direction of a base of the housing part. The contour is formed such that, after the cover is attached to the housing part, the contour is positioned on a region of the sensor connector that points to the wire harness.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic sectional illustration of a system housing with cover, sensor and sensor connector, viewed in an X-direction, according to an embodiment of the present disclosure;

FIG. 2 shows a schematic sectional illustration of the system housing shown in FIG. 1, viewed in a Y-direction;

FIG. 3 shows a schematic sectional illustration of the system housing shown in FIGS. 1 and 2, viewed in a Z-direction; and

FIGS. 4 to 6 show an assembly sequence of the cover with a restraint system according to an embodiment of the present disclosure.

### DETAILED DESCRIPTION

In an embodiment, the present disclosure provides an additional restraint for plug connectors designed as sensor connectors.

Provided is a sensor system housing having a housing part with a sensor disposed therein, and a sensor connector which is disposed therein and is specified to connect the sensor to a wire harness introduced into the housing part through an insertion region, and a cover that seals the housing part after assembly, wherein provided on a lower side of the cover that after assembly points into the housing part is a restraint system which blocks the sensor connector from sliding out of the sensor, wherein the restraint system is formed from a peg which protrudes from the lower side of the cover and has a contour that, proceeding from the lower side of the cover, leads in the direction of the base of the housing part, and wherein the contour is formed in such a manner that, after attaching the cover to the housing part, said contour is positioned on a region of the sensor connector that points to the wire harness.

In an embodiment, it is provided that the restraint system has a pin that adjoins the contour, and wherein provided on a housing base of the housing part is a socket which is positioned in such a manner that the pin is inserted therein during assembly in order to guide and to position the cover.

In an embodiment, it is provided that the socket is formed as a depression in the housing base.

In an embodiment, it is provided that the length of the contour and of the pin corresponds to the height of the sensor system housing plus the height of the depression.

In an embodiment, it is provided that the contour, after attaching the cover, rests on the region of the sensor connector that points to the wire harness, or is positioned at a predetermined spacing therefrom.

In an embodiment, it is provided that a length and shape of the contour is selected at least in such a manner that, after attaching the cover to the housing part, said contour in the direction of the housing base at least slightly protrudes beyond an upper region of the sensor connector that points to the cover.

Further provided is a steering system having the sensor system housing described.

Further features and advantages of the present disclosure are derived from the description hereunder of exemplary embodiments with reference to the figures of the drawing showing details according to the present disclosure. The individual features can each be implemented individually or as a plurality in any desired combination in a variant of the present disclosure.

Identical elements or functions are provided with the same reference signs in the following description of the figures.

The present disclosure provides a restraint system for a sensor connector which is disposed in a sensor system housing and which connects a sensor disposed in the sensor system housing to a wire harness introduced into the sensor system housing through an insertion region into the housing part. The system housing has a housing part and a cover that seals the housing part after assembly. Primarily, a sensor (with sensor housing and plug socket for connecting to the sensor connector) and the sensor connector are disposed in the housing part. The sensor connector thus is positioned between the sensor and the wire harness. Due to an error when connecting the sensor connector to the sensor, the sensor connector may be released from the sensor, i.e. the sensor connector can slide out of the sensor (more specifically out of its plug socket) toward the wire harness. Such sliding out can block the restraint system according to the present disclosure.

The advantages of integrating the restraint system according to the present disclosure for the sensor connector within the sensor system housing 1 are listed hereunder:
A sensor connector known from the prior art and with or without an internal restraint can be used.
A system-inherent, customizable component is used to provide the restraint system, so no additional subcomponent is required.
The risk of pinching wires/lines due to blind plugging by the technician is minimized.
A required spacing from electrical parts during assembly and final assembly is provided to protect against short circuits.
The risk of cover misalignment is prevented.
The risk of rubbing of wires/lines on the restraint system due to vibrations is prevented, which also provides protection against short circuits.
It provides precise positioning of the restraint system relative to the sensor connector housing without damaging sub-components during assembly.

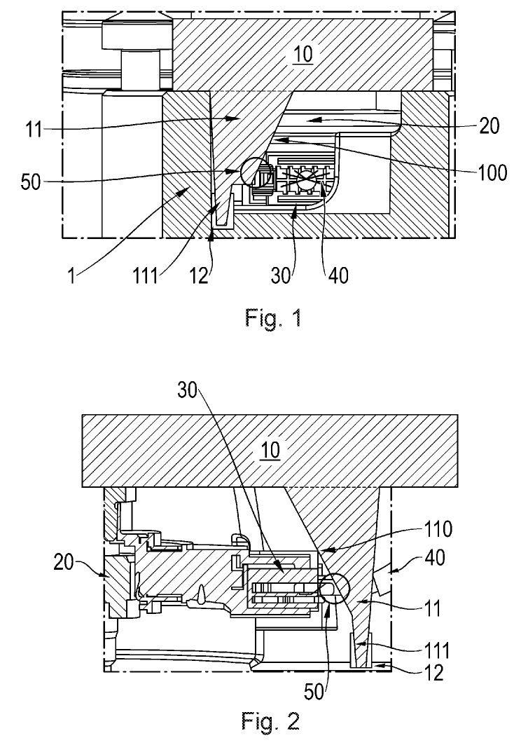

In order to achieve the aforementioned advantages, the following design modifications are made to the cover 10 of the sensor system housing 1. A description is provided with reference to the figures, which represent a preferred embodiment. FIG. 1 shows a schematic sectional illustration in the X-direction through a sensor system housing 1, in which a sensor 20 is disposed and contacted by a wire harness 40 by way of a sensor connector 30. FIG. 2 shows a section in the Y-direction through the sensor system housing 1 shown in FIG. 1.

The present disclosure proceeds from a modification of the cover 10 of a sensor system housing 1 installed in a vehicle. The main modification is that provided on the lower side of the cover 10 is a specially profiled peg 11 which during and after assembly points in the direction of the internal region of the sensor system housing 1. The cover can be formed, for example, as a metal part. A preferred embodiment of the restraint system for application in a sensor system housing 1 is shown in FIGS. 1 to 3. In a preferred embodiment, proceeding from the lower side of the cover 10 on the side that faces the sensor 20, the peg 11 is formed as an oblique contour 110 (seen in section as an oblique edge). The latter terminates on a narrow region, hereinafter referred to as pin 111, which serves as a positioning aid when assembling the cover 10, as described hereunder.

For assembling the cover 10, the pin 111 in this preferred embodiment is inserted into a socket 12, which is provided in the housing base of the housing part of the sensor system housing 1 and formed as a depression therein. By inserting the pin 111 into the socket 12, the cover 10 and thus also the oblique contour 110 are aligned (positioned) in such a way during assembly that no wires are pinched or mechanical parts are damaged. For the technician, the socket 12 has the advantage that by inserting the pin 111, the technician receives haptic feedback that the cover 10 has been positioned without any wires having been pinched. A particularly long pin 111 has the advantage for the technician that the latter even is able to carry out a visual check during assembly. The length of the pin 111 is a function of the design of the sensor system housing 1.

The height of the oblique contour 110 and of the pin 111 corresponds to the height of the housing part of the sensor system housing 1 plus the depth of the socket 12, i.e. the depth of the depression in the housing base. The length of the oblique contour 110 is to be chosen in such a way that it is positioned in such a manner on a region of the sensor connector 30 that points to the wire harness that sliding out of the sensor connector 30 from the sensor 20 (more specifically from the plug socket) is prevented when the pin 111 is inserted in the socket 12 (thus after assembly).

The length of the pin 111 should be chosen as long as possible to simplify the assembly, more specifically the positioning of the cover 10 during assembly. Depending on the length of the pin 111, the incline of the oblique contour 110 can be selected to be steeper or flatter. In the embodiment shown, the peg 11 has a conical shape, at least in those regions in which it serves as a restraint system, wherein the pin 111 represents the tip of the cone.

After the final assembly of the sensor system housing 1, thus after fastening the cover 10 to the housing part, the pin 111 is inserted into the socket 12 (completely) and locked therein (before the cover 10 is completely closed), such that the cover 10 and the oblique contour 110 are aligned and the cover 10 completely seals the housing part.

The present disclosure has been described using the example of an oblique contour 110 as shown in FIGS. 1 to 3. However, the shape of contour 110 is not limited to an oblique contour 110. In an alternative embodiment, the peg 11 can only be formed as a straight contour 110 with or without a pin 111 for positioning, or as a contour 110 without a pin 111. In the absence of a pin 111, the contour 110 can either extend to the housing base (and stand thereon) or terminate at a spacing therefrom. It is important that the contour 110 is used as a restraint system after the cover 10 has been fastened, so that the sensor connector 30 cannot slide out of the sensor 20 (more specifically from the plug socket). In principle, any shape on contour 110 that achieves the effect described can be chosen, specifically providing the restraint system without wires being pinched during its installation.

The shape of the contour 110 serves to keep the peg 11 as far away as possible from the wire harness 40 and from the sensor connector 30 during assembly (i.e. while attaching the cover 10 to the housing part).

After assembly, the contour 110, which is used to block the sensor connector 30 from slipping out of the sensor 20 (more specifically from the plug socket), is positioned on a region of the sensor connector 30 that points to the wire harness. Should an incline be provided, the latter at least partially protrudes beyond the upper region of the sensor connector 30 that points to the cover 10. The contour 110 either rests on the sensor connector 30 or has a (an ideally small) spacing therefrom. In this instance, the contour 110 provides a restraining region 50 which blocks any sliding of the sensor connector 30 out of the sensor 20. When the contour 110 is formed as an oblique contour 110, as in the embodiment shown in the figures, it provides by way of its incline, the latter widening in the direction of the cover 10 (and thus protruding beyond the sensor connector 30), the restraining region 50, as is indicated in FIGS. 2, 4 and 6, by which any sliding of the sensor connector 30 out of the sensor 20 is blocked. Moreover, it is even better ensured during assembly that no electrical components such as wires are pinched or mechanical components are damaged by the application of the cover 10.

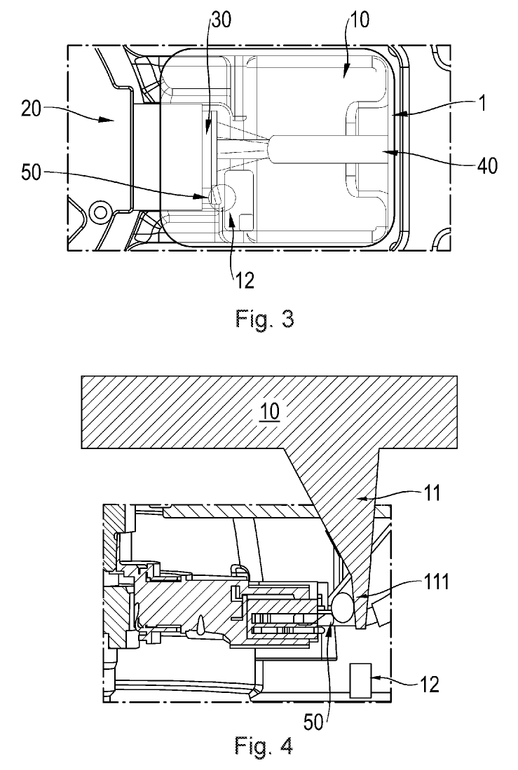

A sectional view from above, i.e. in the Z-direction, onto the sensor system housing 1 shown in FIGS. 1 and 2, is shown in FIG. 3. It can be seen here that the peg 11 is not provided over the entire width of the cover 10, but only in a region on the sensor connector 30 into which the wire harness 40 is introduced, and next to the wire harness 40.

The assembly steps are described hereunder by means of FIGS. 4 to 6. Once the sensor 20, the sensor connector 30, and the wire harness 40 have been incorporated into the housing part of the sensor system housing 1 and the sensor 20 has been connected to the wire harness 40 via the sensor connector 30, the housing part is sealed with the cover 10. The technician can only check the internal setup to a limited extent, so blind assembling is performed. The novel restraint system consisting of or comprising the cover 10 and the peg 11 reduces the risk of pinching or damage to wires of the wire harness 40 or in the region of the sensor connector 30. For this purpose, the peg 11 as described is designed in such a manner that a specific spacing (restraining region 50 in the figures) from the sensor connector 30 and from the wires of the wire harness 40 is present during assembly, this being ensured in particular by the shape of the contour 110. After assembly, the contour 110 of the peg 11 is positioned in such a manner that it prevents the sensor connector 30 from slipping out of the sensor 20.

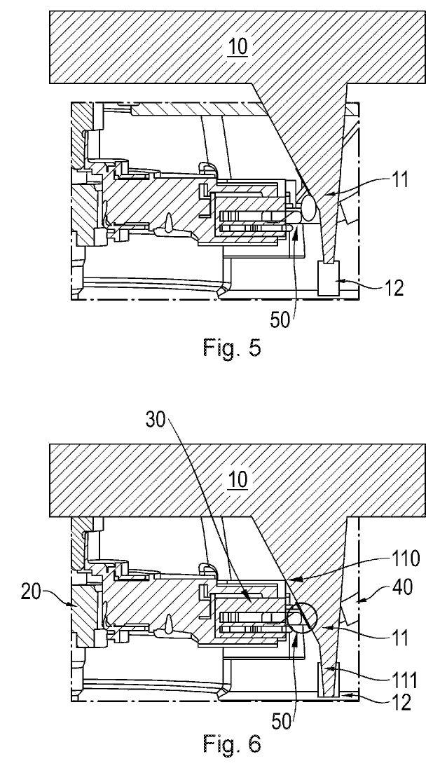

FIG. 4 illustrates the cover 10 being attached to the housing part. As already described, the cover 10 is formed in such a manner that it has a peg 11 which is fastened to a lower side of the cover 10 (or formed integrally with the cover 10) and after assembly is disposed in the housing part. Furthermore, the end region opposite the cover 10 is formed as a kind of pin 111 (narrow region, foot), which is incorporated into a corresponding socket 12 in the base of the housing part during assembly of the cover 10, so that the cover 10 is aligned as indicated in FIG. 5. This enables barrier-free assembly for the technician. The longer the peg 11, the less "blindness” in the assembly, and the technician has more control over the assembly process. When the pin 111 is fully incorporated into the socket 12, the contour 110 of the peg 11 is co-aligned with the region of the sensor connector 30 (the contour 110 rests on the sensor connector 30 or has only a very small spacing therefrom). Thus, the cover 10 with the peg 11 represents an external restraint system independent of the sensor connector, since the sensor connector 30 can no longer slide out of the sensor 20. FIG. 6 shows the restraint system after assembly. Here it can be seen that the contour 110 is positioned on a region of the sensor connector 30 in such a manner that sliding out of the sensor 20 (more specifically out of the plug socket) in the direction of the wire harness is prevented. The contour 110 shown in FIGS. 4 to 6 has an incline, but can also have a different shape, as described above.

Embodiments of the present disclosure can be applied in the automotive sector and in particular in sensor systems in which a high level of safety must be adhered to. For example, the disclosed restraint system can be used in steering applications. A sensor used in a steering system can be a steering torque/steering angle sensor. Here, the sensor system housing is part of the steering system.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS (PART OF THE DESCRIPTION)

1 Sensor system housing

10 Cover

11 Peg

110 Oblique contour

111 Pin

12 Socket for peg

20 Sensor

30 Sensor connector

40 Wire harness

50 Restraining region

1. A sensor system housing, comprising:
a housing part with a sensor disposed therein and a sensor connector disposed therein, the sensor connector being configured to connect the sensor to a wire harness introduced into the housing part through an insertion region; and
a cover configured to seal the housing part after assembly, a restraint system configured to block the sensor connector from sliding out of the sensor being provided on a lower side of the cover that points into the housing part after assembly,
wherein the restraint system is formed from a peg which protrudes from the lower side of the cover and has a contour that, proceeding from the lower side of the cover, leads in a direction of a base of the housing part, and
wherein the contour is formed such that, after the cover is attached to the housing part, the contour is positioned on a region of the sensor connector that points to the wire harness.

2. The sensor system housing as claimed in claim 1, wherein the restraint system has a pin that adjoins the contour, and wherein a socket is provided on a housing base of the housing part, the socket being positioned such that the pin is inserted into the socket during assembly to guide and position the cover.

3. The sensor system housing as claimed in claim 2, wherein the socket is formed as a depression in the housing base.

4. The sensor system housing as claimed in claim 3, wherein a height of the contour and of the pin corresponds to a height of the sensor system housing plus a height of the depression.

5. The sensor system housing as claimed in claim 1, wherein the contour is configured to, after being attached to the cover, rest on the region of the sensor connector that points to the wire harness or be positioned at a predefined spacing therefrom.

6. The sensor system housing as claimed in claim 1, wherein a length and shape of the contour is configured such that, after the cover is attached to the housing part, the contour in the direction of the housing base protrudes at least partially beyond an upper region of the sensor connector that points to the cover.

7. A steering system having the sensor system housing as claimed in claim 1.
